(19) United States
(12) Patent Application Publication
(10) Pub. No.: US 2020/0065919 A1
(43) Pub. Date: Feb. 27, 2020

(54) IDENTIFYING TRAVEL OPTIONS BASED ON DESTINATION WEATHER

(71) Applicant: Brilliant Points, Inc., Reno, NV (US)

(72) Inventor: Christopher Glenn Hansen, Lehi, UT (US)

(21) Appl. No.: 16/378,224

(22) Filed: Apr. 8, 2019

Related U.S. Application Data
(60) Provisional application No. 62/720,404, filed on Aug. 21, 2018.

(51) Int. Cl. G06Q 50/14; G06Q 30/02; G06Q 30/06; H04L 29/08; G01W 1/10

(52) U.S. Cl. CPC G06Q 50/14; G06Q 30/0283; G01W 2203/00; H04L 67/306; G01W 1/10; G06Q 30/0623

(57) ABSTRACT

An example method may include determining a desirability of weather of a destination and determining a travel cost to travel to the destination. In some embodiments, the method may also include presenting, to a user, the destination, an indication of the desirability of weather of the destination, the travel cost, and a specific upcoming time period for travel without receiving any information from the user regarding a time period for travel. In these or other embodiments, the method may also include presenting, to the user, the destination, the indication, the travel cost, and a specific upcoming time period for travel without receiving any information from the user regarding preferred weather conditions. In these or other embodiments, the method may also include presenting, to the user, the destination, the indication, the travel cost, and a specific upcoming time period for travel without receiving any information from the user regarding the destination.

### CROSS-REFERENCE TO RELATED APPLICATION

This application claims priority to and the benefit of U.S. provisional application No. 62/720,404, filed Aug. 21, 2018, which is incorporated herein by reference in its entirety.

### FIELD

The embodiments discussed in the present disclosure are related to identifying travel options based on destination weather.

### BACKGROUND

Unless otherwise indicated herein, the materials described herein are not prior art to the claims in the present application and are not admitted to be prior art by inclusion in this section.

Many people enjoy traveling to destinations for personal pleasure. Some destinations are more enjoyable in certain weather conditions than in other weather conditions. Many people enjoy different types of activities at their respective travel destinations. Some types of activities are more enjoyable in certain weather conditions than in other weather conditions.

The subject matter described in the present disclosure is not limited to embodiments that solve any disadvantages or that operate only in environments such as those described above. Rather, this background is only provided to illustrate one example technology area where some embodiments described in the present disclosure may be practiced.

### SUMMARY

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

Some embodiments described herein generally relate to identifying travel options based on destination weather.

In an example embodiment, a method may include determining a desirability of weather of a destination and determining a travel cost to travel from an origin to the destination. The method may also include, without receiving any information from a user regarding a time period for travel, presenting, to the user, the destination, the travel cost, a specific upcoming time period for travel, and an indication of the desirability of the weather of the destination.

In another example embodiment, a method may include determining a desirability of weather of a destination and determining a travel cost to travel from an origin to the destination. The method may also include, without receiving any information from a user regarding preferred weather conditions, presenting, to the user, the destination, the travel cost, a specific upcoming time period for travel and an indication of the desirability of the weather of the destination.

In another example embodiment, a method may include determining a desirability of weather of a destination and determining a travel cost to travel from an origin to the destination. The method may also include, without receiving any information from a user regarding the destination, presenting, to the user, the destination, the travel cost, a specific upcoming time period for travel, and an indication of the desirability of the weather of the destination.

In one or more embodiments, the method may also include determining multiple desirabilities, each of the multiple desirabilities corresponding to weather of the destination during a different upcoming time period of multiple upcoming time periods. The method may also include, determining multiple travel costs to travel from the origin to the destination, each of the multiple travel costs corresponding to a corresponding different upcoming time period of the multiple upcoming time periods. The method may also include, ranking the multiple upcoming time periods based on one or more of the multiple desirabilities and the multiple travel costs. The method may also include, presenting, to the user, according to the ranking, the destination, the multiple travel costs, the multiple upcoming time periods, and one or more indications of the desirability of the weather of the destination.

In one or more embodiments, the method may also include determining multiple desirabilities, each of the multiple desirabilities corresponding to weather of a different destination of multiple destinations. The method may also include, determining multiple travel costs to travel from the origin to the multiple destinations, each of the multiple travel costs corresponding to a corresponding different destination of the multiple destinations. The method may also include, ranking the multiple destinations based on one or more of the multiple desirabilities and the multiple travel costs. The method may also include, presenting, to the user, according to the ranking, the multiple destinations, the multiple travel costs, the specific upcoming time period, and one or more indications of the desirability of the weather of the multiple destinations.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope The invention will be described and explained with additional specificity and detail through the use of the accompanying drawings in which:

FIG. 1 is a block diagram of an example operating environment to identify travel options based on destination weather;

FIGS. 2A-2E are block diagrams of example presentations of travel options;

FIG. 3 is a flow chart of an example process to identify travel options based on destination weather;

FIG. 4 is a flow chart of another example process to identify travel options based on destination weather;

FIG. 5 is a flow chart of yet another example process to identify travel options based on destination weather; and

FIG. 6 is a block diagram of an example computing system, all arranged according to at least one embodiment described in the present disclosure.

### DESCRIPTION OF EMBODIMENTS

The present disclosure relates to identifying travel options based on destination weather.

Many people enjoy traveling to destinations for personal pleasure. Some destinations are more enjoyable in certain weather conditions than in other weather conditions. Many people enjoy different types of activities at their respective travel destinations. Some types of activities are more enjoyable in certain weather conditions than in other weather conditions. The systems and methods of the present disclosure may identify travel options based on the weather of the travel destinations. In the present disclosure, the term “travel options” may include information regarding one or both of a destination for travel, and an upcoming time period during which to travel, e.g. to the destination. The systems and methods of the present disclosure may be further configured to present information regarding the travel options to a user. Information regarding a travel option may include such things as the destination and the upcoming time period of the travel option. The information regarding a travel option may further include travel costs and indications of the desirability of weather of the destination, for example, weather scores corresponding to the destination and the upcoming period of time.

For example, a person may have an opportunity to travel for a vacation. The person may or may not have a destination in mind. The person may or may not know when the person would like to travel. The person may use the systems and methods of the present disclosure to obtain information regarding a destination and/or an upcoming time period during which to travel to the destination. The information may be based on and/or include information regarding the weather of the destination, including a weather forecast and/or predicted weather of the destination during the upcoming time period. Additionally or alternatively, the information may be based on and/or include information regarding travel cost to travel to the destination. The systems and methods of the present disclosure may present the information to the person, including presenting the destination, information about the weather of the destination during the upcoming time period, the travel cost, and the upcoming time period.

For example, a person may have an opportunity to travel on the soonest upcoming weekend. The person may use the systems and methods of the present disclosure to obtain information regarding a destination that has a desired weather condition. For example, the person may live in a location that is currently relatively cold. The person may wish to visit a warmer destination for the weekend. The systems and methods of the present disclosure may be configured to obtain a weather forecast for multiple destinations and, based on the desired weather condition, determine for which destination or destinations to provide information to the person. Additionally or alternatively, the systems and methods of the present disclosure may be configured to determine, based on travel costs of the destinations, for which destination or destinations to provide information to the person. The systems and methods of the present disclosure may be configured to present the information to the person according to a ranking based on the weather forecast and the travel costs.

As another example, a person may have a destination in mind, but the person may want to find a desirable time to visit the destination. The person may use the systems and methods of the present disclosure to obtain information regarding when to visit the destination. The systems and methods of the present disclosure may obtain historical weather data for the destination along with travel cost information for the destination. The systems and methods of the present disclosure may be configured to predict a weather forecast for the destination for multiple upcoming periods of time. The systems and methods of the present disclosure may further be configured to determine, based on a desired weather condition and/or travel costs of the destination, for which upcoming time period or upcoming time periods for the person to visit the destination to provide information to the person.

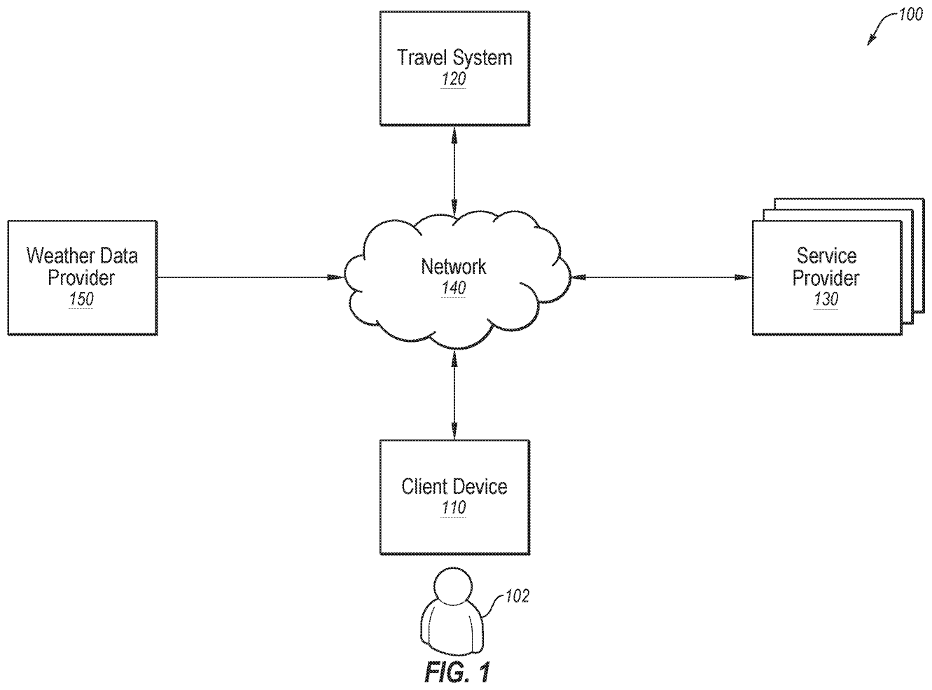

FIG. 1 is a block diagram of an example operating environment 100 to identify travel options based on destination weather according to at least one embodiment described in the present disclosure. The environment 100 may include a user 102, a client device 110, a travel system 120, one or more service providers 130, a network 140, and one or more weather data providers 150.

In general, the user 102 may use the client device 110 to communicate with the travel system 120 via the network 140 The user 102 may request travel information from the travel system 120. The travel system 120 may be configured to obtain weather data from the weather data provider 150 and cost data from the service providers 130. The travel system 120 may be configured to identify travel options and compile the travel information based on the cost data and the weather data. The travel system 120 may be configured to present the travel options and/or the travel information to the user 102 via the client device 110.

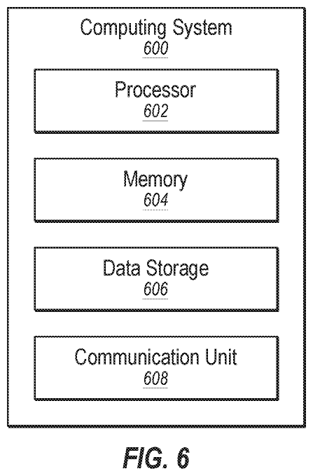

The client device 110 may include a computing system through which the user 102 may obtain information over the network 140. The client device 110 may include any suitable computing system to interact with a website. For example, the client device may include a personal computer, a laptop, a tablet, or a smart phone. An example implementation of the client device 110 is illustrated in FIG. 6 as a computing system 600.

The network 140 may include hardware and software configured to communicatively couple computing systems. The network 140 may include any suitable hardware and software for communicatively coupling computing systems. For example, the network 140 may include a local area network (LAN), a wide area network (WAN), a cellular radio frequency (RF) network, and/or the Internet. The network 140 may communicatively couple the travel system 120 with the client device 110. Additionally or alternatively, the network 140 may communicatively couple the travel system 120 with the service providers 130 and/or the weather data provider 150. Additionally or alternatively, in some embodiments, the network 140 may communicatively couple the client device 110 with the service providers 130.

The weather data provider 150 may include one or more databases of weather data or one or more services configured to provide weather data. The weather data may be queried and supplied to the travel system 120 over the network 140. The weather data may include information such as hourly temperatures, daily high temperatures, daily low temperatures, hourly indications of precipitation, wind speeds, whether the sky will be sunny or cloudy, and humidity. The weather data may include forecasts, for example a current day forecast, a current weekend forecast, a current three-day forecast, a current ten-day forecast, and/or other forecasts. Alternatively or additionally, the weather data may include historical weather data, such as daily high and/or low temperatures for one or more prior years or portions thereof, daily or monthly precipitation for one or more prior years or portions thereof, and/or other historical weather data. The weather data may include data regarding weather at multiple locations. For example, the weather data may include information for locations anywhere and/or everywhere in the world. Alternatively or additionally, the weather data may include weather information for one or more cities with at least one airport, train station, or other travel hub in one or more countries in the world.

The service providers 130 may include providers of travel-related services, for example, airlines, train lines, bus lines, hotels, car rental agencies, global distribution system providers and travel agencies. The service providers 130 may have computing systems, e.g., databases, accessible to the network 140. Thus, the service providers 130 may provide cost data related to various services to the travel system 120.

The travel system 120 may include any suitable computing system, for example, a computing server and/or a web server. The computing system 600 of FIG. 6 may be an example implementation of the travel system 120.

The travel system 120 may be configured to obtain a request from the user 102 to receive information about destinations and associated weather and travel costs. In some embodiments, the travel system 120 may receive the request through a mobile application, a website accessible on the Internet, or through other channels (e.g., email or SMS opt-in request).

The travel system 120 may be configured to determine one or more desirabilities of weather associated with one or more destinations and/or one or more period of time. The desirability of weather may be determined by the satisfaction of criteria. For example, weather with temperature within a range may be determined to be desirable weather. Additionally or alternatively, multiple factors, such as, temperature ranges, precipitation, and wind speed may be used to determine the desirability of weather. Additionally or alternatively, a weather score may be an example of a determination of desirability of weather. In some embodiments, the weather score may represent a quantification of the desirability of weather.

As an example of determining the desirability of weather, the travel system 120 may be configured to obtain weather data, e.g. from the weather data provider 150, and score weather conditions of the one or more destinations based on the weather data. In some embodiments, the travel system 120 may be configured to rank the one or more destinations according to the weather scores associated with the one or more destinations. As an example of how the travel system 120 may be used, a user 102 may indicate or otherwise identify an upcoming time period (e.g., a specific time period beginning on a first specific date and ending on a second specific date) and the travel system 120 may be configured to provide a list of destinations ranked according to the weather scores of the destinations for the time period.

In some embodiments, the travel system 120 may be configured to determine one or more desirabilities associated with a destination corresponding to one or more upcoming time periods For example, the travel system 120 may be configured to determine a different weather score for each day of an upcoming month for a single destination. As an example of how the travel system 120 may be used, a user 102 may indicate a destination to which the user 102 desires to travel The travel system 120 may be configured to score the weather conditions of the destination for multiple upcoming time periods and present to the user 102 a list of time periods ranked according to the weather scores corresponding to time periods.

In some embodiments, the travel system 120 may be configured to determine desirabilities of weather conditions of multiple destinations for multiple time periods. For example, the travel system 120 may score the weather conditions of each of ten different destinations for each week of the summer. As an example of how the travel system 120 may be used, a user 102 may indicate that the user 102 wishes to travel, without indicating any specific destination and without indicating a specific time period. The travel system 120 may be configured to score the weather conditions for each of ten different destinations for each week of a ten week period, resulting in one hundred different weather scores. The travel system 120 may rank the destinations and time periods according to the weather scores and present the rankings to the user 102.

In some embodiments, determining a desirability of weather of a destination may include determining a weather condition for an upcoming period of time. In instances where the upcoming period of time is relatively soon, e.g., within sixteen days, the travel system 120 may be configured to obtain a current weather forecast from the weather data provider 150. The weather data provider 150 may provide current weather forecasts, for example, sixteen-day weather forecasts. In instances where the upcoming period of time is relatively long, e.g., more than sixteen days, and/or falls at least partially outside the current weather forecast, the travel system 120 may be configured to predict a weather forecast for the upcoming period of time. For example, the travel system 120 may be configured to obtain historical weather data (e.g., from the weather data provider 150) and predict a weather forecast by using a predictive model based on the historical weather data. The predictive model may determine an average of high and/or low temperatures and/or precipitation for a given hour/day/week/month over multiple past years to predict a weather forecast for the same hour/day/week/month in the future, or the predictive model may be more simple or complex or consider different or additional information.

In some embodiments, the travel system 120 may be configured to determine the desirability of the weather condition according to one or more factors, for example, a pre-defined weather criteria, a criteria based on preferences of the user, a criteria based on indicated activities of the user 102, and a criteria based on preferences of other people. For example, the travel system 120 may include pre-predefined weather criteria that define particular temperature ranges and precipitation levels as high-scoring weather conditions.

As a particular example of how the travel system 120 may determine a desirability of weather conditions, the travel system 120 may calculate a weather score according to, e.g., the methodology described at www.meteovista.com (hereinafter the meteovista methodology) and summarized as follows. The weather score may be based solely on the daytime weather without considering nighttime. The calculation may start with a 10 and deduct points for, e.g., wind, cloud, precipitation and mist. For example, a sunny, dry day with little wind may score a 10.

To determine the contribution of clouds to the weather score, the calculation may determine average cloud cover using the forecast between 7 am and 7 pm. A value of 0 may be deducted from the weather score if the average is equal to or smaller than ⅛. A value of 1 may be deducted if the average is between 2/8 and ⅝. A value of 2 may be deducted if the average is between 6/8 and ⅞. A value of 3 may be deducted if the average is more than ⅞.

To determine the contribution of fog and/or mist to the weather score, the duration of expected daytime fog and mist is determined. A value of 0 may be deducted from the weather score if there is no fog or mist forecast. A value of 1 may be deducted if less than 3 hours of fog or mist is forecast. A value of 2 may be deducted if there is more than 3 hours of mist forecast.

To determine the contribution of precipitation to the weather score, the duration of expected rainfall is determined. A value of 0 may be deducted from the weather score if less than 10 minutes of rain is forecast. A value of 1 may be deducted for 10-90 minutes of rain in the forecast. A value of 2 may be deducted for 90-300 minutes of rain in the forecast. A value of 3 may be deducted for 300-500 minutes of rain in the forecast. A value of 4 may be deducted for more than 500 minutes of rain in the forecast.

To determine the contribution of wind to the weather score, the daytime maximum wind strength (average of 10 minutes) may be determined, e.g., on the Beaufort wind force scale or equivalent. A value of 0 may be deducted from the weather score if this is 0-2. A value of 1 may be deducted if this is 3. A value of 2 may be deducted if this is 4 or 5. A value of 3 may be deducted if this is 6 or more.

Theoretically it is possible to get a weather score of less than 1. If this happens the weather score may be kept as 1. The temperature is not included in the weather score according to the meteovista methodology, although it may be included in other weather score calculations.

Embodiments described herein may alternatively or additionally determine activity-specific weather desirability. For example, a beach weather score, a winter sports weather score, and a water sports weather score may each be based on expected/forecast precipitation, wind strength, sunshine hours, mist and fog, temperature, and/or risk of thunderstorms. However, each of the activity-specific weather scores may weight various criteria differently. For example, the expected/forecast wind and risk of thunderstorms may be given added value for the water sports weather score; the expected/forecast temperature, mist and fog, and risk of thunderstorms may be given added value for the beach weather score; and the expected/forecast temperature may be given added value for the winter sports weather score.

Additionally or alternatively, the travel system 120 may be configured to obtain weather preferences from the user 102 and generate weather desirabilities particular to the user 102. For example, the travel system 120 may query the user regarding the preferred weather conditions of the user 102 generally, and/or for a specific upcoming vacation. The travel system 120 may be configured to score the weather conditions based on a similarity between the weather conditions and the preferred weather conditions of the user 102.

Additionally or alternatively, the travel system 120 may collect preferred weather conditions from multiple people, e.g., other users of the travel system 120, and determine desirabilities of the weather conditions based on a similarity between the weather conditions and the weather conditions preferred by multiple, e.g. a majority, of the people In some embodiments, the weather conditions preferred by multiple people may be relative to a destination, for example, a majority of users may indicate that they prefer the weather conditions of Moscow, Russia in July to the weather conditions of Moscow, Russia in January.

Additionally or alternatively, the travel system 120 may be configured to obtain information about one or more activities of the user 102. For example, the travel system 120 may query the user 102 regarding which activities the user 102 may wish to participate in on an upcoming vacation and/or the user may identify, e.g., in a user profile, activities the user is interested in year-round and/or during specific time periods of the year. The travel system 120 may be configured to generate activity-specific weather desirabilities as already mentioned above, and/or the travel system 120 may be configured to determine desirabilities of the weather conditions based on a similarity between the weather conditions and previously identified desirable weather conditions for the activities indicated by the user 102. For example, the user 102 may indicate an interest in snow skiing. The travel system 120 may have previously identified information that indicates that the day after a heavy snow storm is a great day for snow skiing. Based on this information, the travel system 120 may score a weather condition including a day after a snow storm highly.

Additionally or alternatively, the travel system 120 may be configured to determine the desirability of weather conditions with reference to one or more activities as already indicated above. As such, the weather scores may be associated with one or more activities. For example, weather conditions that include sunny days and temperatures above 70 degrees Fahrenheit may have a higher beach weather score than weather conditions that include sunny days and temperatures below 70 degrees Fahrenheit.

In some embodiments, the travel system 120 may be configured to determine a travel cost to travel from an origin to the destination. The travel system 120 may be configured to determine the origin of the user 102 based on an Internet Protocol (IP) address of the client device 110 and/or a Global Positioning System (GPS) derived location of the client device 110. Thus, the travel system 120 may be configured to determine the origin without input from the user 102. In other embodiments, the travel system 120 may determine the origin based on input from the user 102, e.g., the user may specify an “origin city” in a profile of the user and/or in response to a query from the travel system 120.

In some embodiments, the travel system 120 may be configured to determine the travel costs based on cost data obtained from the service providers 130. The travel costs may include such things as airline tickets, bus line tickets, train tickets, hotel reservations, car rentals, and/or other travel costs. The travel system 120 may be configured to query the service providers 130 to obtain specific costs for specific services for specific dates.

The travel system 120 may be configured to rank destinations and/or time periods according to the travel costs, for example, lowest cost first. Additionally or alternatively, the travel system 120 may include options selectable by a user 102. For example, the user 102 may be able to indicate a budget or upper limit of costs beyond which destinations and/or time periods are not to be presented to the user. Additionally or alternatively, the user 102 may be able to indicate that the user 102 is not interested in staying in a hotel with less than a three star ranking or a hotel that costs less than one hundred dollars per night.

As an example of how the travel system 120 may be used, a user 102 may indicate a desire to travel without indicating a destination or a time period. The travel system 120 may obtain (e.g. from the service providers 130) costs of airline tickets to ten cities for each of ten different time periods, resulting in one hundred different ticket prices. The travel system 120 may rank the airline ticket costs according to price and present the ranked airline ticket costs, associated with the different destinations and time periods to the user 102.

In some embodiments, the travel system 120 may be configured to rank destinations and/or time periods according to one or both of weather desirabilities and travel costs. For example, the travel ranking and presentation of the destinations and/or time periods may be based on weighted averages between the weather scores and the travel costs.

In some embodiments, the travel system 120 may be configured to present to the user 102, via the client device 110, one or more destinations and one or more time periods and travel costs and weather scores (and/or other indications of the desirability of the weather) corresponding to the one or more destinations and one or more time periods. The presentation may be according to the ranking of the destinations and/or time periods.

In some embodiments, the travel system 120 may be configured to book services with the service providers 130. For example, the travel system 120 may be configured to present one or more services of the service providers 130 to the user 102 via the client device 110. In response to receiving a confirmation from the user 102, the travel system 120 may be configured to book the services with the service providers 130. Additionally or alternatively, the user 102 may be able to book the services with the service providers 130. For example, the travel system 120 may present one or more services to the user 102 via the client device 110. The user 102 may be able to book the services with the service providers 130 without further involvement of the travel system 120.

In some embodiments, the travel system 120 may be configured to determine desirability of weather, determine travel costs, rank the destinations and/or time periods based on one or both of the desirability of the weather and the travel costs, and present the destinations and/or time periods with the corresponding travel costs and an indication of the desirability of the weather (e.g., the travel score) all without receiving any information from the user regarding a time period for travel. Four examples of operations of the travel system 120 without receiving any information from the user 102 regarding a time period for travel are described.

In a first example, a user 102 may have a specific destination to which the user 102 desires to travel. The user 102 may use the travel system 120 to obtain information regarding when to travel to the destination and/or to determine a travel cost and a weather score for each of multiple different time periods for travel to the specific destination. The user 102 may indicate to the travel system 120 the destination. Thereafter the travel system 120 may determine multiple weather scores for multiple time periods. For example, the travel system 120 may obtain current forecasts for the destination for time periods that are within one week from the current time. Additionally or alternatively, the travel system 120 may predict, based on historical weather data, a weather forecast for time periods that are later then one week from the current time. Additionally, the travel system 120 may obtain cost data (e.g., travel costs) for the destination for each of the periods of time from the service providers 130. The travel system 120 may present the travel costs and weather scores for each of the time periods to the user 102, optionally ranked by travel cost, weather score, or a combination of the two.

In a second example, a user 102 may have a destination in mind and a preferred weather condition for visiting the destination. The user 102 may use the travel system 120 to obtain information regarding when the user 102 may experience a preferred weather condition at the destination and/or to determine a travel cost and a weather score for each of multiple different time periods for travel to the specific destination. The user 102 may indicate to the travel system 120 their preferred weather condition, for example, as part of a user profile, and the destination the user 102 wishes to visit. The travel system 120 may be configured to obtain multiple weather scores for the destination relative to the preferred weather condition for each of multiple upcoming time periods. The travel system 120 may also obtain travel costs for each of the multiple upcoming time periods. The travel system 120 may be configured to present the travel costs and weather scores of each of the multiple time periods according to the user 102, optionally ranked according to the weather scores and/or the travel costs.

In a third example, a user 102 may receive travel information based on a preferred activity. For example, the user 102 may indicate an interest in an activity without any reference to the time period. For example, a browser history and/or user profile of a user 102 may indicate that the user 102 is interested in snow skiing. The travel system 120 may be configured to identify one or more destinations that have a high weather score associated with snow skiing (e.g., based on a current forecast) and a low travel cost for an upcoming time period. The travel system 120 may be configured to present to the user 102 the one or more destinations, the weather scores, the travel costs, and the dates of the upcoming time periods, for example, through an email.

In a fourth example, a user 102 may receive notifications including information about travel options (including travel costs and/or weather scores) that may be of interest to the user 102, without the user 102 having provided information regarding a time period for travel. For example, the user 102 may have indicated an interest in a destination, weather conditions, or an activity. The travel system 120 may be configured to regularly search for weather scores and travel costs to destinations that align with the indicated interests of the user 102. The travel system 120 may be configured to provide the user 102 with a regular notification of upcoming travel options that may be of interest to the user 102, for example, through a daily or weekly email. In some embodiments, the daily or weekly email may include travel options for the soonest upcoming weekend. The daily or weekly email may include information about travel options including the travel costs and/or the weather scores to various destinations. The information may be presented according to a ranking based on the travel scores and/or weather scores.

In some embodiments, the travel system 120 may be configured to determine desirability of weather, determine travel costs, rank the destinations and/or time periods based on one or both of the desirability of the weather and the travel costs, and present the destinations and/or time periods with the corresponding travel costs and an indication of the desirability of the weather (e.g., the travel score) all without receiving any information from the user regarding preferred weather conditions. Three examples of operations of the travel system 120 without receiving any information from the user 102 regarding preferred weather conditions are described.

In a first example, a user 102 may be presented with time periods for travel to a destination based on a similarity between weather preferences of others and predicted weather conditions. For example, the user 102 may have indicated an interest in travel to Prague. The travel system 120 may be configured to compare the weather preferences of other users for visiting Prague with the predicted weather conditions of Prague. Based on a correlation between weather conditions for an upcoming time period and the weather preferences of others for Prague, the travel system 120 may be configured to present Prague and the upcoming time period to the user. Additionally or alternatively, the travel system 120 may be configured to present to the user a listing of time periods for visiting Prague along with travel costs and weather scores for each of the time periods. The listing may be ranked based on one or both of the weather scores and travel costs.

In a second example, a user 102 may be presented with destinations based on estimated preferable weather conditions. For example, a user 102 may live in a region that has experienced a long cloudy rainy period. The user may be looking for a vacation destination for an upcoming time period, for example, the soonest upcoming weekend. The travel system 120 may be configured to estimate that the user 102 might enjoy travel to a destination with warm and sunny predicted weather conditions. Therefore, the travel system 120 may be configured to present to the user 102 travel destinations that have predicted warm and sunny weather conditions. Additionally or alternatively, the travel destinations may be ranked according to one or both of weather scores and costs.

In a third example, a user 102 may have a vacation planned to a destination for an upcoming time period. The user 102 may use the travel system 120 to determine what the weather conditions may be. For example, the travel system 120 may be configured to use the weather data to predict a forecast for the destination for the upcoming time period and present the forecast to the user 102.

In some embodiments, the travel system 120 may be configured to determine desirability of weather, determine travel costs, rank the destinations and/or time periods based on one or both of the desirability of the weather and the travel costs, and present the destinations and/or time periods with the corresponding travel costs and an indication of the desirability of the weather (e.g., the travel score) all without receiving any information from the user identifying a specific destination. One example of operations of the travel system 120 without receiving any information from the user 102 regarding the destination is described.

In an example, a user may desire to travel during an upcoming time period without a preference regarding destination. The upcoming time period may be, for example, the soonest upcoming weekend, or weeks in the future. The user 102 may obtain from the travel system 120 destinations for the upcoming time period. For example, the travel system 120 may be configured to determine weather scores and travel costs for multiple destinations for the specific upcoming time period. The travel system 120 may be configured to rank the destinations according to one or both of the weather scores and the travel costs and present the ranked destinations to the user 102.

Modifications, additions, or omissions may be made to the environment 100 without departing from the scope of the present disclosure. For example, the travel system 120 may maintain its own weather data and may thus omit the weather data provider 150. Further, the order of operations may vary according to different implementations.

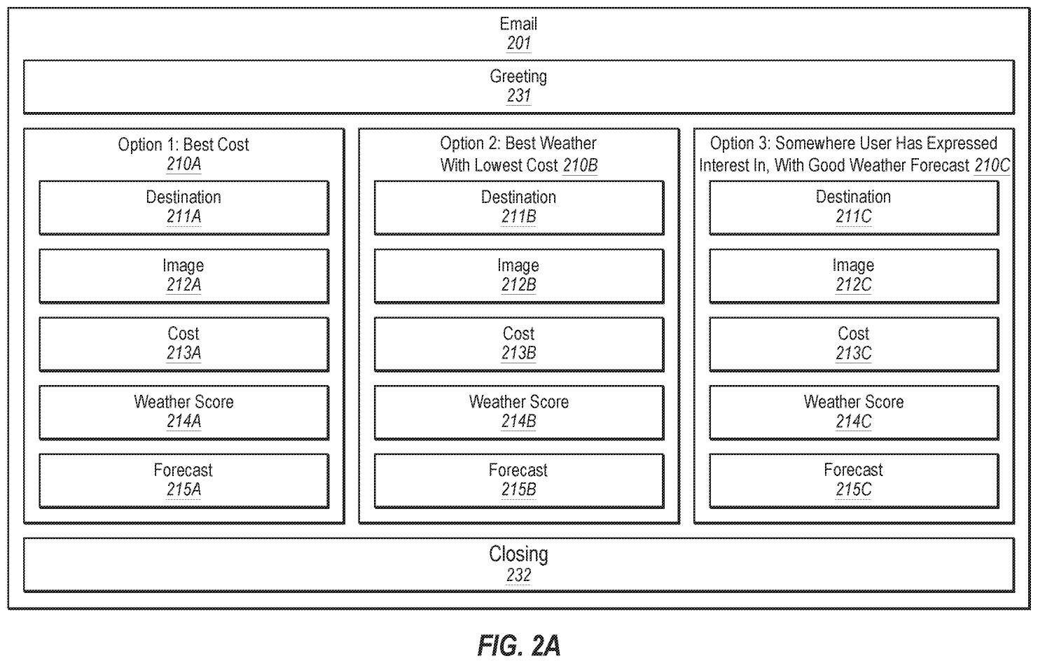

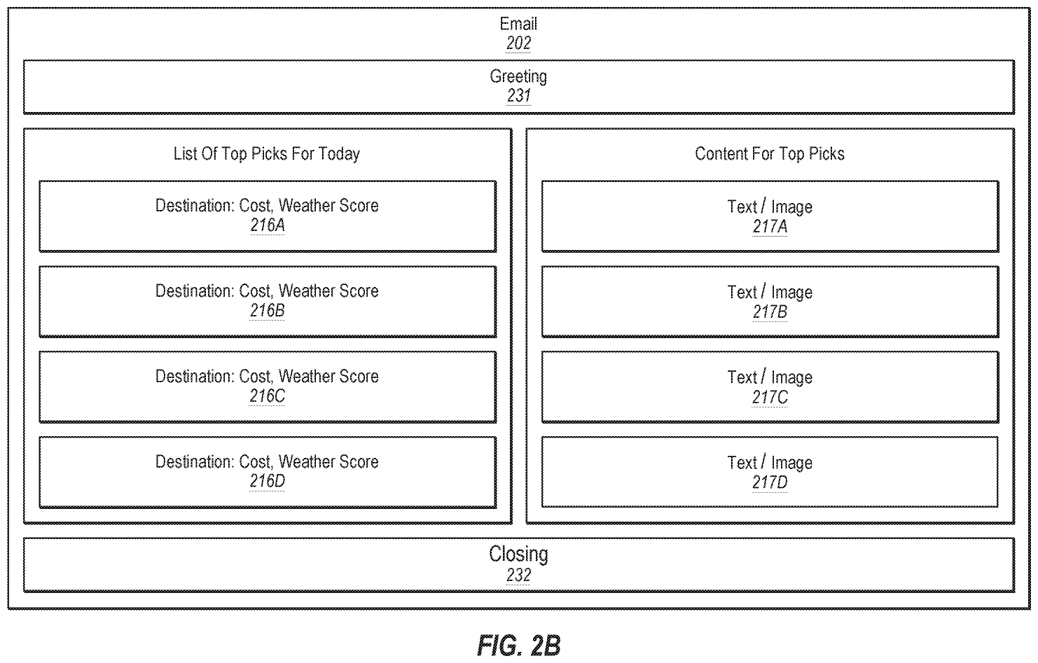

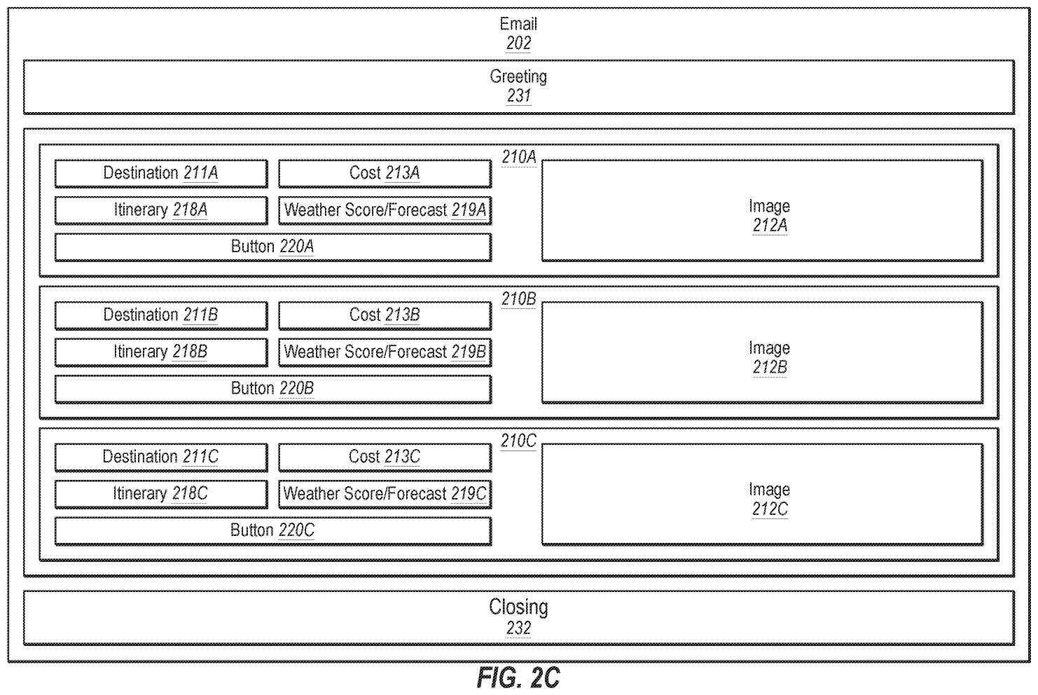

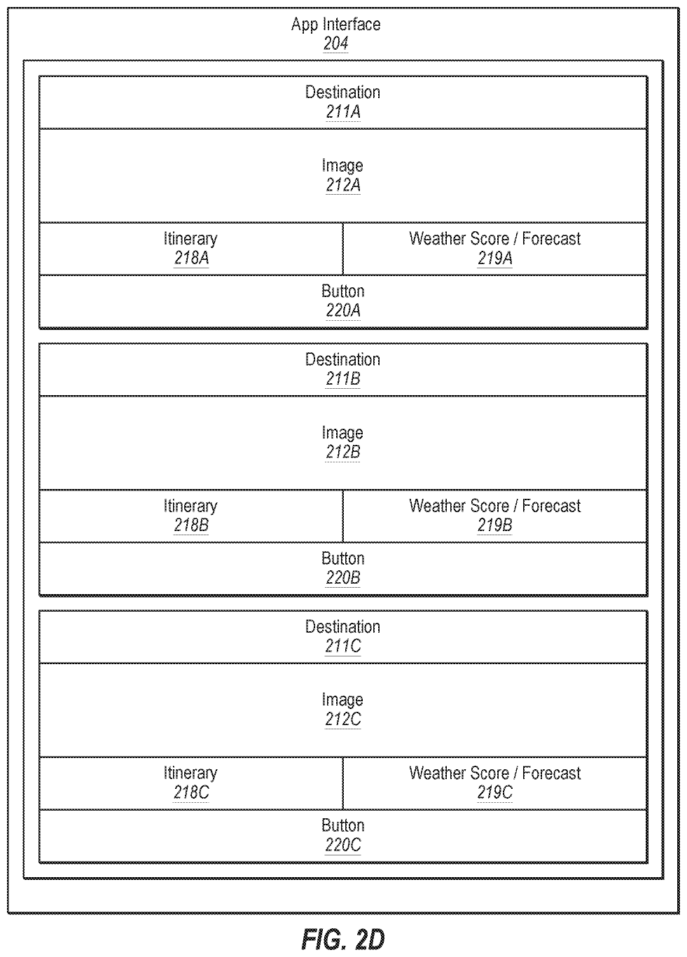

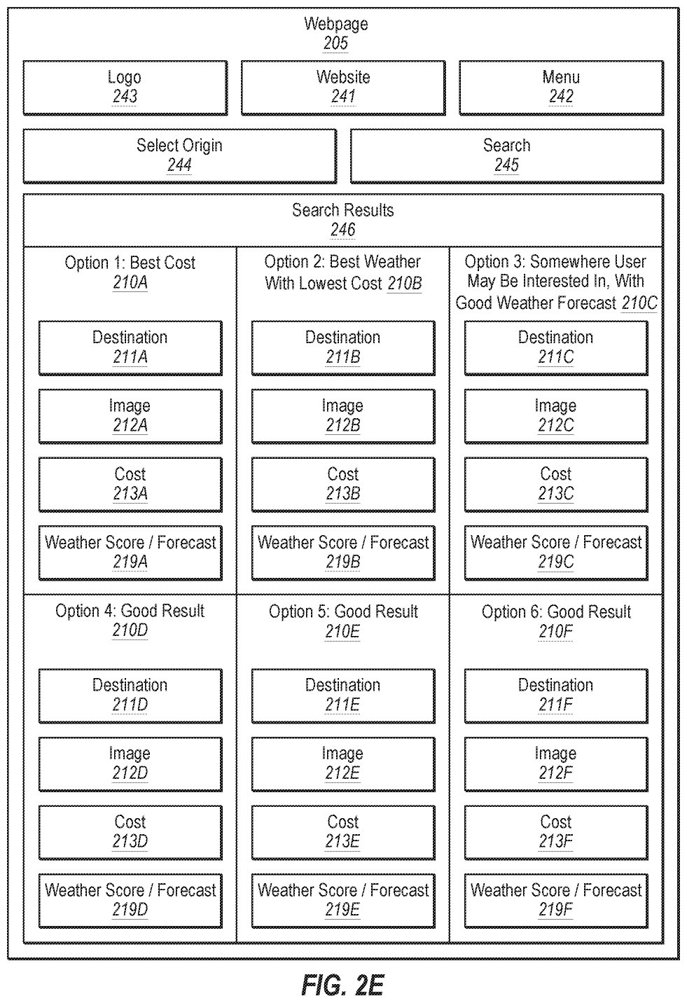

FIGS. 2A-2E are block diagrams of example presentations of travel options according to at least one embodiment described in the present disclosure. For example, the travel system 120 of FIG. 1 may be configured to present destinations with associated upcoming time periods, desirabilities of weather (e.g., weather scores), and/or costs to the user 102 of FIG. 1 via the client device 110 of FIG. 1 according to one or more of these example presentations.

FIG. 2A is a block diagram of an example email 201 including travel options. The email 201 includes three options, a first option 210A, a second option 210B, and a third option 210C (collectively referred to as options 210). The options 210 may include travel destinations and/or time periods. The first option 210A includes a first destination 211A, a first image 212A, a first cost 213A, a first weather score 214A, and a first forecast 215A. The second option 210B includes a second destination 211B, a second image 212B, a second cost 213B, a second weather score 214B, and a second forecast 215B. The third option includes a third destination 211C, a third image 212C, a third cost 213C, a third weather score 214C, and a third forecast 215C.

The first destination 211A, the second destination 211B, and the third destination 211C may be collectively referred to as destinations 211. The destinations 211 may include text describing the geographic location of the destination, for example, a name of a city or region.

The first image 212A, the second image 212B, and the third image 212C may be collectively referred to as images 212. The images 212 may relate to the destinations 211, and in some embodiments, the images 212 may relate to the destination 211 and the time period or according to the forecasts 215. For example, the image 212A may include a photograph of a popular site related to the destination 212A, the photograph having been taken during weather conditions similar to or the same as the weather conditions of the forecast 215A.

The first cost 213A, the second cost 213B, and the third cost 213C may be collectively referred to as costs 213. The costs 213 may include the cost of one or more of airline tickets, bus line tickets, train tickets, hotel reservations, car rentals, and/or other travel costs for roundtrip (or one-way) travel between the origin of the user and the corresponding destination 211 for a corresponding upcoming time period.

The first weather score 214A, the second weather score 214B, and the third weather score 214C may be collectively referred to as the weather scores 214. The weather scores 214 may be an example of an indication of the desirability of the weather of the destinations 211 during the upcoming time periods. For example, the weather scores 214 may include a number, for example a number between one and ten or a number of stars for example, between one and five stars. The weather score 214 may be presented as a number or as an icon, text, or graphic.

The forecast 215A, the forecast 215B, and the forecast 215C may be collectively referred to as the forecasts 215. The forecasts 215 may include information such as one or more of temperature, precipitation, cloudiness, and wind for the corresponding destination 211 during the corresponding upcoming time period. The forecasts 215 may represent such information with numbers and/or icons.

The email 201 may also include a greeting 231 and a closing 232. The greeting 231 and/or the closing 232 may include text describing the options 210 and/or how to select one or more of the options 210. One or more portions of the options 210 may include hyperlinks. For example, each of the costs 213 may include a corresponding hyperlink such that selecting a corresponding one of the costs 213 (e.g., by mouse click, touch input, or other user input) may redirect a browser of the user to a website through which the user may purchase travel (e.g., airfare and hotel reservation) associated with the corresponding option 210.

The email 201 is an example of a presentation of travel options along with associated costs, and weather scores. In some embodiments the options 210 may also include (though not illustrated) upcoming time periods for the travel. The upcoming time periods may be included in the options 210 and/or in one or both of the greeting 231 and the closing 232.

Modifications, additions, or omissions may be made to the email 201 without departing from the scope of the present disclosure. For example, the email 201 may include the destination in the greeting 231 and/or the closing 232 and omit the destinations 211 from the options 210. As a particular example, in an instance where the user has indicated an interest in a particular destination, the options 210 may include upcoming time periods in the place of the destinations 211 and the destination may be listed in the greeting 231 and/or the subject line of the email 201.

FIG. 2B is a block diagram of another example email 202 including travel options. The email 202 includes four summaries 216, a first summary 216A, a second summary 216B, a third summary 216C, and a fourth summary 216D (collectively referred to as summaries 216). Each of the summaries 216 may include a destination and a cost and a weather score, and/or other indication of the desirability of the weather, associated with the destination. The destination, cost, and weather score may be and/or include text.

Additionally, the email 202 includes four descriptions 217 a first description 217A, a second description 217B, a third description 217C, and a fourth description 217D (collectively referred to as descriptions 217). Each of the descriptions 217 may include text and/or images describing and/or associated with the destination. The descriptions 217 may describe the destination and the predicted weather associated with the upcoming time period. For example, the first description 217A may include a photograph of a popular site associated with the destination, the photograph having been taken during weather conditions similar to or the same as the weather conditions predicted for the upcoming time period. The email 202 may also include a greeting 231 and a closing 232.

The email 202 is an example of a presentation of travel options along with associated costs, and weather scores. In some embodiments the options 210 may also include (though not illustrated) upcoming time periods for the travel. The upcoming time periods may be included in one or both of the greeting 231 and the closing 232.

One or more elements of the email 202, such as each of the costs within each of the summaries 216, may include a hyperlink that a user may select to purchase travel associated with the destination specified in a corresponding one of the summaries 216.

Modifications, additions, or omissions may be made to the email 202 without departing from the scope of the present disclosure. For example, the email 201 may include the destination in the greeting 231 and/or the closing 232 and omit the destinations 211 from the summaries 216. As a particular example, in an instance where the user has indicated an interest in a particular destination, the summaries 216 may include upcoming time periods in the place of the destinations and the destination may be listed in the greeting 231 and/or the subject line of the email 201.

FIG. 2C is a block diagram of an example email 203 including travel options. The email 203 includes three options, a first option 210A, a second option 210B, and a third option 210C (collectively referred to as options 210). The first option 210A includes a first destination 211A, a first image 212A, a first cost 213A, a first itinerary 218A, a first weather description 219A, and a first button 220A. The second option 210B includes a second destination 211B, a second image 212B, a second cost 213B, a second itinerary 218B, a second weather description 219B, and a second button 220B. The third option 210C includes a third destination 211C, a third image 212C, a third cost 213C, a third itinerary 218C, a third weather description 219C, and a third button 220C.

The first itinerary 218A, the second itinerary 218B, and the third itinerary 218C may be collectively referred to as the itineraries 218. The itineraries 218 may include a representation of the upcoming time period associated with the options 210. For example, the first itinerary 218A may include a representation of the upcoming time period associated with option 210A for travel to the destination 211A. The itineraries 218 may include dates and/or times of day, for example, airline departure and/or arrival times associated with the options 210.

The first weather description 219A, the second weather description 219B, and the third weather description 219C may be collectively referred to as the weather descriptions 219. The weather descriptions 219 may include one or both of the weather scores (and/or another indication of the desirability of the weather of the destination) and or information representing weather forecasts corresponding to the destinations 211 during the corresponding upcoming time periods. For example, the weather descriptions 219 may include a weather score, colored according to a forecasted temperature. Further, the weather descriptions 219 may include icons representing precipitation or cloudiness. The weather descriptions 219 may be an example of indications of desirability of weather of the destinations during the upcoming time periods.

The first button 220A, the second button 220B, and the third button 220C may be collectively referred to as the buttons 220. The buttons 220 may include options available to the user relative to the options 210. For example, the buttons 220 may include a button to purchase one of the travel options. Additionally or alternatively, the buttons 220 may include a button allowing a user to like, or share the options 210.

The email 203 is an example of a presentation of travel options along with associated costs, weather scores, and upcoming time periods.

Modifications, additions, or omissions may be made to the email 203 without departing from the scope of the present disclosure.

FIG. 2D is a block diagram of an example app interface 204 including travel options. The app interface 204 includes three options, a first option, a second option, and a third option (collectively referred to as options). The first option includes a first destination 211A, a first image 212A, a first itinerary 218A, a first weather description 219A, and a first button 220A. The second option includes a second destination 211B, a second image 212B, a second itinerary 218B, a second weather description 219B, and a second button 220B. The third option includes a third destination 211C, a third image 212C, a third itinerary 218C, a third weather description 219C, and a third button 220C.

The app interface 204 is an example of a presentation of travel options along with associated weather scores, and upcoming time periods. In some embodiments, the app interface 204 may also display costs associated with each of the options 210.

Modifications, additions, or omissions may be made to the app interface 204 without departing from the scope of the present disclosure.

FIG. 2E is a block diagram of an example webpage 205 including travel options. The webpage 205 includes six options, a first option 210A, a second option 210B, a third option 210C, a fourth option 210D, a fifth option 210E, and a sixth option 210F (collectively referred to as options 210). The first option includes a first destination 211A, a first image 212A, a first cost 213A, and a first weather description 219A. The second option includes a second destination 211B, a second image 212B, a second cost 213B, and a second weather description 219B. The third option includes a third destination 211C, a third image 212C, a third cost 213C, and a third weather description 219C. the fourth option 210D includes a fourth destination 211D, a fourth image 212D, a fourth cost 213D, and a fourth weather description 219D. The fifth option 210E includes a fifth destination 211E, a fifth image 212E, a fifth cost 213E, and a fifth weather description 219E. The sixth option 210F includes a sixth destination 211F, a sixth image 212F, a sixth cost 213F, and a sixth weather description 219F.

The webpage 205 may also include a webpage title 241, a menu 242, a logo 243, a select origin button 244, and a search button 245. In some embodiments, each of the options 210 may be arranged in a search results 246 portion of the webpage 205.

The webpage 205 is an example of a presentation of travel options along with associated costs, weather scores, and upcoming time periods.

Modifications, additions, or omissions may be made to the webpage 205 without departing from the scope of the present disclosure.

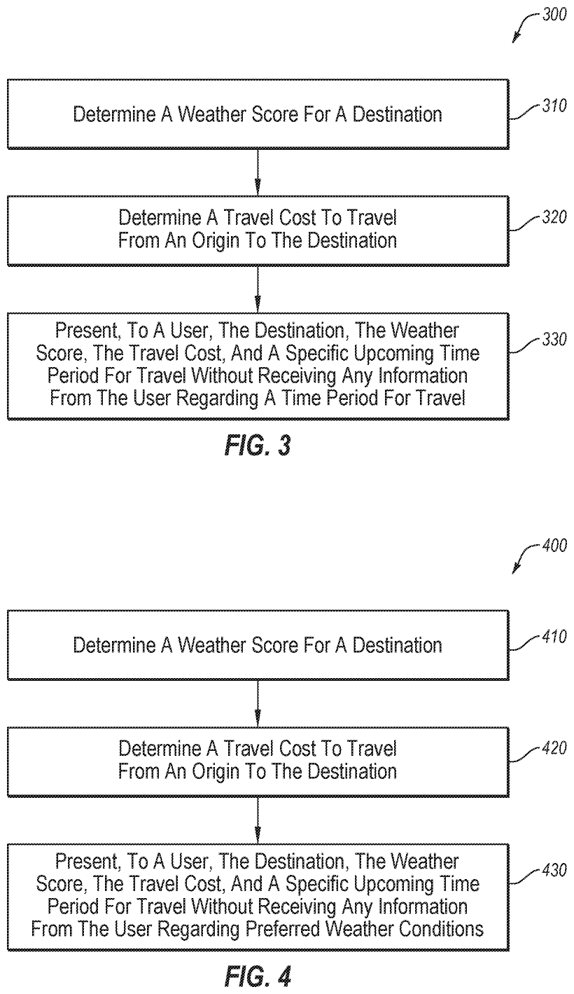

FIG. 3 is a flow chart of an example method 300 to identify travel options based on destination weather, according to at least one embodiment described in the present disclosure. One or more of the operations associated with the method 300 may be performed by one or more elements of the environment 100 of FIG. 1. The method 300 may be performed by any suitable system, apparatus, or device. For example, the computing system 600 of FIG. 6 may perform or control performance of one or more of the operations associated with the method 300. Although illustrated with discrete blocks, the steps and operations associated with one or more of the blocks of the method 300 may be divided into additional blocks, combined into fewer blocks, or eliminated, depending on the desired implementation. The method 300 may begin at a block 310.

At the block 310, a weather score may be determined for a destination. The weather score may be determined by the travel system 120 of FIG. 1 based on weather data from the weather data provider 150 of FIG. 1.

In some embodiments, the destination may be provided by the user. Additionally or alternatively, the method 300 may be preceded by or include receipt of an indication from the user that the user desires to receive information about travel options.

In some embodiments, the weather score may be based on one or more of a current weather forecast or a predicted weather forecast based on a predictive model based on historical weather data. The weather score may be based on a similarity between forecast weather conditions (whether from a current weather forecast or a predicted forecast based on historical data) and one or more of a pre-defined weather criteria, a criteria based on preferences of the user, a criteria based on indicated activities of the user 102, and a criteria based on preferences of other people.

In some embodiments, a weather score may be determined for each of multiple different destinations. Additionally or alternatively a weather score may be determined for each of multiple different upcoming time periods. Additionally or alternatively, a weather score may be determined for each of multiple different destinations for each of multiple different upcoming time periods. The block 310 may be followed by a block 320.

At the block 320, a travel cost may be determined between an origin and the destination. The cost may be determined by the travel system 120 of FIG. 1, e.g., based on cost data from the service providers 130 of FIG. 1. As described above, the cost may include the cost of airline tickets, bus line tickets, train tickets, hotel reservations, and car rentals.

In some embodiments, the origin may be provided by the user. Additionally or alternatively, the origin may be determined based on an IP address of a client device associated with the user and/or based on other information without requiring input from the user that specifically identifies the origin.

In some embodiments, a travel cost may be determined for each of multiple different destinations. Additionally or alternatively, a travel cost may be determined for each of multiple different upcoming time periods. Additionally or alternatively, a travel cost may be determined for each of multiple different destinations for each of multiple different upcoming time periods. The block 320 may be followed by a block 330.

At the block 330, the destination, the weather score (and/or other indications of the desirability of the weather), the travel cost, and a specific upcoming time period for travel may be presented to the user without receiving any information from the user regarding a time period for travel. Throughout the entirety of the method 300, there may be no receipt of any information from the user regarding a time period for travel.

In some embodiments, multiple destinations associated with weather scores and travel costs may be presented to the user. The multiple destinations may be ranked according to one or both of the weather scores and travel costs associated with the multiple destinations.

In some embodiments, multiple time periods associated with weather scores and travel costs for the destination may be presented to the user. The multiple time periods may be ranked according to one or both of the weather scores and the travel costs associated with

In some embodiments, multiple destinations, and multiple time periods for traveling to the multiple destinations, associated with weather scores and travel costs may be presented to the user. The multiple destinations, and the multiple time periods for traveling to the multiple destinations, may be ranked according to one or both of the weather scores and travel costs associated with the multiple destinations, and the multiple time periods for traveling to the multiple destinations.

Modifications, additions, or omissions may be made to the method 300 without departing from the scope of the present disclosure. Further, the order of operations may vary according to different implementations. For example, although illustrated in series, the block 310 and the block 320 may occur in any order or simultaneously.

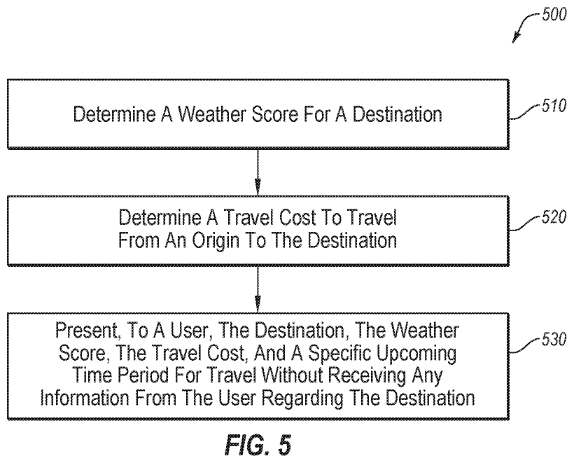

FIG. 4 is a flow chart of an example method 400 to identify travel options based on destination weather, according to at least one embodiment described in the present disclosure. One or more of the operations associated with the method 400 may be performed by one or more elements of the environment 100 of FIG. 1. The method 400 may be performed by any suitable system, apparatus, or device. For example, the computing system 600 of FIG. 6 may perform or control performance of one or more of the operations associated with the method 400. Although illustrated with discrete blocks, the steps and operations associated with one or more of the blocks of the method 400 may be divided into additional blocks, combined into fewer blocks, or eliminated, depending on the desired implementation. The method 400 may begin at a block 410.

At the block 410, a weather score may be determined for a destination. The weather score may be determined by the travel system 120 of FIG. 1 based on weather data from the weather data provider 150 of FIG. 1.

In some embodiments, the destination may be provided by the user. Additionally or alternatively, the method 400 may be preceded by or include receipt of an indication from the user that the user desires to receive information about travel options.

In some embodiments, the weather score may be based on one or more of a current weather forecast or a predicted weather forecast based on a predictive model based on historical weather data. The weather score may be based on a similarity between forecast weather conditions (whether from a current weather forecast or a predicted forecast based on historical data) and one or more of a pre-defined weather criteria, a criteria based on preferences of the user, a criteria based on indicated activities of the user 102, and a criteria based on preferences of other people.

In some embodiments, a weather score may be determined for each of multiple different destinations. Additionally or alternatively a weather score may be determined for each of multiple different upcoming time periods. Additionally or alternatively, a weather score may be determined for each of multiple different destinations for each of multiple different upcoming time periods. The block 410 may be followed by a block 420.

At the block 420, a travel cost may be determined between an origin and the destination. The cost may be determined by the travel system 120 of FIG. 1, e.g., based on cost data from the service providers 130 of FIG. 1. As described above, the cost may include the cost of airline tickets, bus line tickets, train tickets, hotel reservations, and car rentals.

In some embodiments, the origin may be provided by the user. Additionally or alternatively, the origin may be determined based on an IP address of a client device associated with the user and/or based on other information without requiring input from the user that specifically identifies the origin.

In some embodiments, a travel cost may be determined for each of multiple different destinations. Additionally or alternatively a travel cost may be determined for each of multiple different upcoming time periods. Additionally or alternatively, a travel cost may be determined for each of multiple different destinations for each of multiple different upcoming time periods. The block 420 may be followed by a block 430.

At the block 430, the destination, the weather score (and/or other indications of the desirability of the weather), the travel cost, and a specific upcoming time period for travel may be presented to the user without receiving any information from the user regarding preferred weather conditions. Throughout the entirety of the method 400, there may be no receipt of any information from the user regarding preferred weather conditions.

In some embodiments, multiple destinations associated with weather scores and travel costs may be presented to the user. The multiple destinations may be ranked according to one or both of the weather scores and travel costs associated with the multiple destinations.

In some embodiments, multiple time periods associated with weather scores and travel costs for the destination may be presented to the user. The multiple time periods may be ranked according to one or both of the weather scores and the travel costs associated with the time periods.

In some embodiments, multiple destinations, and multiple time periods for traveling to the multiple destinations, associated with weather scores and travel costs may be presented to the user. The multiple destinations, and the multiple time periods for traveling to the multiple destinations, may be ranked according to one or both of the weather scores and travel costs associated with the multiple destinations, and the multiple time periods for traveling to the multiple destinations.

Modifications, additions, or omissions may be made to the method 400 without departing from the scope of the present disclosure Further, the order of operations may vary according to different implementations. For example, although illustrated in series, the block 410 and the block 420 may occur in any order or simultaneously.

FIG. 5 is a flow chart of an example method 500 to identify travel options based on destination weather, according to at least one embodiment described in the present disclosure. One or more of the operations associated with the method 500 may be performed by one or more elements of the environment 100 of FIG. 1. The method 500 may be performed by any suitable system, apparatus, or device. For example, the computing system 600 of FIG. 6 may perform or control performance of one or more of the operations associated with the method 500. Although illustrated with discrete blocks, the steps and operations associated with one or more of the blocks of the method 500 may be divided into additional blocks, combined into fewer blocks, or eliminated, depending on the desired implementation. The method 500 may begin at a block 510.

At the block 510, a weather score may be determined for a destination. The weather score may be determined by the travel system 120 of FIG. 1 based on weather data from the weather data provider 150 of FIG. 1.

In some embodiments, the method 500 may be preceded by or include receipt of an indication from the user that the user desires to receive information about travel options.

In some embodiments, the weather score may be based on one or more of a current weather forecast or a predicted weather forecast based on a predictive model based on historical weather data. The weather score may be based on a similarity between forecast weather conditions (whether from a current weather forecast or a predicted forecast based on historical data) and one or more of a pre-defined weather criteria, a criteria based on preferences of the user, a criteria based on indicated activities of the user 102, and a criteria based on preferences of other people.

In some embodiments, a weather score may be determined for each of multiple different destinations. Additionally or alternatively a weather score may be determined for each of multiple different upcoming time periods. Additionally or alternatively, a weather score may be determined for each of multiple different destinations for each of multiple different upcoming time periods. The block 510 may be followed by a block 520.

At the block 520, a travel cost may be determined between an origin and the destination. The cost may be determined by the travel system 120 of FIG. 1, e.g., based on cost data from the service providers 130 of FIG. 1. As described above, the cost may include the cost of airline tickets, bus line tickets, train tickets, hotel reservations, and car rentals.

In some embodiments, the origin may be provided by the user. Additionally or alternatively, the origin may be determined based on an IP address of a client device associated with the user and/or based on other information without requiring input from the user that specifically identifies the origin.

In some embodiments, a travel cost may be determined for each of multiple different destinations. Additionally or alternatively a travel cost may be determined for each of multiple different upcoming time periods. Additionally or alternatively, a travel cost may be determined for each of multiple different destinations for each of multiple different upcoming time periods. The block 520 may be followed by a block 530.

At the block 530, the destination, the weather score (and/or other indications of the desirability of the weather), the travel cost, and a specific upcoming time period for travel may be presented to the user without receiving any information from the user regarding the destination Throughout the entirety of the method 500, there may be no receipt of any information from the user regarding the destination.

In some embodiments, multiple destinations associated with weather scores and travel costs may be presented to the user. The multiple destinations may be ranked according to one or both of the weather scores and travel costs associated with the multiple destinations.

In some embodiments, multiple time periods associated with weather scores and travel costs for the destination may be presented to the user. The multiple time periods may be ranked according to one or both of the weather scores and the travel costs associated with the time periods.

In some embodiments, multiple destinations, and multiple time periods for traveling to the multiple destinations, associated with weather scores and travel costs may be presented to the user. The multiple destinations, and the multiple time periods for traveling to the multiple destinations, may be ranked according to one or both of the weather scores and travel costs associated with the multiple destinations, and the multiple time periods for traveling to the multiple destinations.

Modifications, additions, or omissions may be made to the method 500 without departing from the scope of the present disclosure. Further, the order of operations may vary according to different implementations. For example, although illustrated in series, the block 510 and the block 520 may occur in any order or simultaneously.

One skilled in the art will appreciate that, for the environment 100, the method 300 the method 400, the method 500, and other processes and methods disclosed herein, the functions performed in the processes and methods may be implemented in differing order. Furthermore, the outlined steps and actions are only provided as examples, and some of the steps and actions may be optional, combined into fewer steps and actions, or expanded into additional steps and actions without detracting from the essence of the disclosed embodiments.

FIG. 6 is a block diagram of an example computing system 600, arranged according to at least one embodiment described in the present disclosure. As illustrated in FIG. 6, the computing system 600 may include a processor 602, a memory 604, a data storage 606, and a communication unit 608.

Generally, the processor 602 may include any suitable special-purpose or general-purpose computer, computing entity, or processing device including various computer hardware or software modules and may be configured to execute instructions stored on any applicable computer-readable storage media. For example, the processor 602 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. Although illustrated as a single processor in FIG. 6, it is understood that the processor 602 may include any number of processors distributed across any number of network or physical locations that are configured to perform individually or collectively any number of operations described herein In some embodiments, the processor 602 may interpret and/or execute program instructions and/or process data stored in the memory 604, the data storage 606, or the memory 604 and the data storage 606. In some embodiments, the processor 602 may fetch program instructions from the data storage 606 and load the program instructions in the memory 604. After the program instructions are loaded into the memory 604, the processor 602 may execute the program instructions, such as instructions to perform one or more operations described with respect to the travel system 120 of FIG. 1 and/or with respect to any of the methods 300, 400, 500 of FIGS. 3-5.

The memory 604 and the data storage 606 may include computer-readable storage media or one or more computer-readable storage mediums for carrying or having computer-executable instructions or data structures stored thereon. Such computer-readable storage media may be any available media that may be accessed by a general-purpose or special-purpose computer, such as the processor 602. By way of example, such computer-readable storage media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 602 to perform a certain operation or group of operations. In these and other embodiments, the term “non-transitory” as explained herein should be construed to exclude only those types of transitory media that were found to fall outside the scope of patentable subject matter in the Federal Circuit decision of In re Nuijten, 500 F.3d 1346 (Fed. Cir. 2007). Combinations of the above may also be included within the scope of computer-readable media.

The communication unit 608 may be configured to receive messages, for example, weather data, cost data, indications from a user, and reservations described with respect to FIG. 1 and to provide the messages to the data storage 606. The communication unit 608 may include any device, system, component, or collection of components configured to allow or facilitate communication between the computing system 600 and a network. For example, the communication unit 608 may include a modem, a network card (wireless or wired), an infrared communication device, an optical communication device, a wireless communication device (such as an antenna), and/or chipset (such as a Bluetooth device, an 802.6 device (e.g. Metropolitan Area Network (MAN)), a Wi-Fi device, a WiMAX device, cellular communication facilities, etc.), and/or the like. The communication unit 608 may permit data to be exchanged with any network such as a cellular network, a Wi-Fi network, a MAN, an optical network, etc., to name a few examples, and/or any other devices described in the present disclosure, including remote devices.

Modifications, additions, or omissions may be made to the computing system 600 without departing from the scope of the present disclosure. For example, the data storage 606 may be located in multiple locations and accessed by the processor 602 through a network.

As used herein, the travel system 120 of FIG. 1 may refer to hardware implementations configured to perform the operations of the travel system 120 and/or software objects or software routines that may be stored on and/or executed by general-purpose hardware (e.g., computer-readable media, processing devices, etc.) of the computing system 600. In some embodiments, the different components, modules, engines, and services described herein may be implemented as objects or processes that execute on the computing system 600 (e.g., as separate threads).

While some of the system and methods described herein are generally described as being implemented in software (stored on and/or executed by general-purpose hardware), specific hardware implementations or a combination of software and specific hardware implementations are also possible and contemplated. In this description, a “computing entity” may be any computing system as previously defined herein, or any module or combination of modulates running on a computing system.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.” Additionally, use of the term “and/or” in some places does not mean that the term “or” should be understood to only include either of the terms as opposed to including the possibility of both terms.

Additionally, the use of the terms “first,” “second,” “third,” etc., are not necessarily used herein to connote a specific order or number of elements Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first, “second,” “third,” etc., connote a specific number of elements, these terms should not be understood to connote a specific number of elements For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A method comprising:
determining a desirability of weather of a destination;
determining a travel cost to travel from an origin to the destination; and
without receiving any information from a user regarding a time period for travel, presenting, to the user, the destination, the travel cost, a specific upcoming time period for travel, and an indication of the desirability of the weather of the destination.

2. The method of claim 1, further comprising:
determining a plurality of desirabilities, each of the plurality of desirabilities corresponding to weather of the destination during a different upcoming time period of a plurality of upcoming time periods;
determining a plurality of travel costs to travel from the origin to the destination, each of the plurality of travel costs corresponding to a corresponding different upcoming time period of the plurality of upcoming time periods;
ranking the plurality of upcoming time periods based on one or more of the plurality of desirabilities and the plurality of travel costs; and
presenting, to the user, according to the ranking, the destination, the plurality of travel costs, the plurality of upcoming time periods, and one or more indications of the desirability of the weather of the destination.

3. The method of claim 1, wherein determining the desirability includes one or both of: obtaining a current weather forecast for the specific upcoming time period or predicting a weather forecast for the specific upcoming time period based on a predictive model, wherein the predictive model is based on historical weather data.

4. The method of claim 1, wherein the travel cost includes one or more of a cost of an airplane ticket, a cost of a train ticket, a cost of a bus ticket, a cost of a hotel, and a cost of a car rental.

5. The method of claim 1, wherein the origin is determined based on an Internet Protocol (IP) address of a device of the user without receiving input from the user that specifies the origin.

6. The method of claim 1, wherein the desirability is based on one or more of: preferences of the user, indicated activities of the user, preferences of other people, and weather criteria.

7. The method of claim 1, further comprising, prior to the presenting, receiving input from the user that identifies the destination.

8. The method of claim 1, wherein the specific upcoming time period is the soonest upcoming weekend from a current time.

9. The method of claim 1, further comprising receiving, from the user, a request to receive information about destinations and associated weather scores and travel costs.

10. The method of claim 1, further comprising obtaining an indication of an online account of the user, wherein presenting to the user comprises sending an electronic communication to the online account.

11. A method comprising:
determining a desirability of weather of a destination;
determining a travel cost to travel from an origin to the destination; and
without receiving any information from a user regarding preferred weather conditions, presenting, to the user, the destination, the travel cost, a specific upcoming time period for travel and an indication of the desirability of the weather of the destination.

12. The method of claim 11, further comprising:
determining a plurality of desirabilities, each of the plurality of desirabilities corresponding to weather of the destination during a different upcoming time period of a plurality of upcoming time periods;
determining a plurality of travel costs to travel from the origin to the destination, each of the plurality of travel costs corresponding to a corresponding different upcoming time period of the plurality of upcoming time periods;
ranking the plurality of upcoming time periods based on one or more of the plurality of desirabilities and the plurality of travel costs; and
presenting, to the user, according to the ranking, the destination, the plurality of travel costs, the plurality of upcoming time periods, and one or more indications of the desirability of the weather of the destination.

13. The method of claim 11, further comprising:
determining a plurality of desirabilities, each of the plurality of desirabilities corresponding to weather of a different destination of a plurality of destinations;
determining a plurality of travel costs to travel from the origin to the plurality of destinations, each of the plurality of travel costs corresponding to a corresponding different destination of the plurality of destinations;
ranking the plurality of destinations based on one or more of the plurality of desirabilities and the plurality of travel costs; and
presenting, to the user, according to the ranking, the plurality of destinations, the plurality of travel costs, the specific upcoming time period, and one or more indications of the desirability of the weather of the plurality of destinations.

14. The method of claim 11, wherein the desirability is based on one or both of preferences of other people and weather criteria.

15. The method of claim 11, further comprising, prior to the presenting, receiving input from the user that identifies the specific upcoming time period.

16. The method of claim 11, further comprising, prior to the presenting, receiving input from the user that identifies the destination.

17. A method comprising:
determining a desirability of weather of a destination;
determining a travel cost to travel from an origin to the destination; and
without receiving any information from a user regarding the destination, presenting, to the user, the destination, the travel cost, a specific upcoming time period for travel, and an indication of the desirability of the weather of the destination.

18. The method of claim 17, further comprising:
determining a plurality of desirabilities, each of the plurality of desirabilities corresponding to weather of a different destination of a plurality of destinations;
determining a plurality of travel costs to travel from the origin to the plurality of destinations, each of the plurality of travel costs corresponding to a corresponding different destination of the plurality of destinations;
ranking the plurality of destinations based on one or more of the plurality of desirabilities and the plurality of travel costs; and
presenting, to the user, according to the ranking, the plurality of destinations, the plurality of travel costs, the specific upcoming time period, one or more indications of the desirability of the weather of the plurality of destinations.

19. The method of claim 17, wherein determining the desirability includes one or both of: obtaining a current weather forecast for the specific upcoming time period or predicting a weather forecast for the specific upcoming time period based on a predictive model, wherein the predictive model is based on historical weather data.

20. The method of claim 17, further comprising, prior to the presenting, receiving input from the user that identifies the specific upcoming time period.
